(19) United States
(12) Patent Application Publication
(10) Pub. No.: US 2025/0092624 A1
(43) Pub. Date: Mar. 20, 2025

(54) NODES FOR OFFSHORE WIND POWER SUBSTRUCTURES MANUFACTURED BY CASTING

(71) Applicant: DAECHANG SOLUTION CO., LTD., Busan (KR)

(72) Inventors: Dae Seong KIM, Busan (KR); Chang Soo LEE, Yangsan-si (KR); Jong Hwa PARK, Busan (KR); Sung Ig PARK, Busan (KR); Soo Been HWANG, Yangsan-si (KR)

(73) Assignee: DAECHANG SOLUTION CO., LTD., Busan (KR)

(21) Appl. No.: 18/566,590

(22) PCT Filed: Jul. 24, 2023
(86) PCT No.: PCT/KR2023/010666

§ 371 Date: Dec. 1, 2023

(30) Foreign Application Priority Data
Nov. 29, 2022 (KR) 10-2022-0162270

(51) Int. Cl. E02B 17/00; F03D 13/25

(52) U.S. Cl. CPC E02B 17/0004; F03D 13/25

(57) ABSTRACT

A node for a lower structure of an offshore wind power generator according to an embodiment of the present invention relates to a node for a lower structure of an offshore wind power generator, which is manufactured by a casting method, the node including a body part into which a main pipe is inserted, a support part which is formed to be branched from the body part at a predetermined angle with respect to a height direction and into which a branch pipe is inserted, and a reinforcement part that protrudes from the body part, forms a predetermined radius of curvature, and thus reinforces coupling between the body part and the support part.

### TECHNICAL FIELD

The present invention relates to a node for a lower structure of an offshore wind power generator, and more particularly, to a node manufactured by a casting method and coupled to a lower structure.

### BACKGROUND ART

Compared to onshore wind power generation, in offshore wind power generation, a large-scale wind farm is easily built, and a large wind turbine is easily installed, but the time and costs of installing a lower structure are excessively high.

Among various lower structures, a jacket type lower structure that is most widely used is a structure formed in a grid shape in which steel pipes are arranged to intersect each other over a large space.

In order to manufacture the jacket type lower structure, ends of the steel pipes should be cut in accordance with a mutual intersection angle, and in order to accurately weld the cut steel pipes, a structure that supports the steel pipes is separately manufactured.

Further, there are many places in which a welding environment is bad. Thus, a worker having a high skill level is required, a large residual stress occurs at a joint as welded portions overlap each other, stress concentration due to the joint of a thin member cannot be avoided, and thus structural safety of the lower structure is weakened.

In recent years, a method of manufacturing a truss joint of the jacket type lower structure through a casting method to reduce a manufacturing time of the lower structure and ensure the stability of the entire structure through ensuring welding quality has been proposed.

In this regard, Korean Patent No. 10-1688194 (Dec. 14, 2016) discloses a branch node of a truss for a lower structure of an offshore wind power generation plant.

However, it is still difficult to secure the stability of the entire lower structure by manufacturing the truss joint of the jacket type lower structure through a casting method.

### DISCLOSURE

### Technical Problem

The present invention is directed to providing a node for a lower structure of an offshore wind power generator, which is manufactured by a casting method and can prevent a stress concentration by adding a connection part and a reinforcement part having a curvature.

The problem to be solved by the present invention is not limited to the above-described problems, and unmentioned problems will be clearly understood by those skilled in the art to which the present invention pertains from the specification and the accompanying drawings.

### Technical Solution

One aspect of the present invention provides a node for a lower structure of an offshore wind power generator according to an embodiment of the present invention, the node including a body part into which a main pipe is inserted, a support part which is formed to be branched from the body part at a predetermined angle with respect to a height direction and into which a branch pipe is inserted, and a reinforcement part that protrudes from the body part and forms a predetermined radius of curvature to reinforce coupling between the body part and the support part, in which the body part is formed such that a thickness of a portion from which the support part initially branches is greater than a thickness of a portion spaced apart from the support part on the basis of the height direction.

### Advantageous Effects

According to a node for a lower structure of an offshore wind power generator according to an embodiment of the present invention, as the node includes a connection part and a reinforcement part having a curvature, when the node is installed on the lower structure, a stress concentration in the structure is prevented, and thus the stability of the lower structure can be improved.

The effect of the present invention is not limited to the above-described effects, and unmentioned effects will be clearly understood by those skilled in the art to which the present invention pertains from the specification and the accompanying drawings.

### DESCRIPTION OF DRAWINGS

FIG. 1 is a schematic view for describing a node for a lower structure of an offshore wind power generator, which is manufactured by a casting method and is installed on a lower structure, according to an embodiment of the present invention.

FIG. 2 is a perspective view for describing a node manufactured by a welding method.

FIG. 3 is a perspective view for describing the node for the lower structure of the offshore wind power generator, which is manufactured by a casting method, according to the embodiment of the present invention.

FIG. 4 is a perspective view for describing a body part constituting the node for the lower structure of the offshore wind power generator, which is manufactured by a casting method, according to the embodiment of the present invention.

FIG. 5 is a partial cross-sectional view for describing the body part constituting the node for the lower structure of the offshore wind power generator, which is manufactured by a casting method, according to the embodiment of the present invention.

FIG. 6 is a side view for describing the body part and a support part constituting the node for the lower structure of the offshore wind power generator, which is manufactured by a casting method, according to the embodiment of the present invention.

FIG. 7 is a schematic view for describing the body part and the support part constituting the node for the lower structure of the offshore wind power generator, which is manufactured by a casting method, according to the embodiment of the present invention.

FIG. 8 is a cross-sectional view for describing the body part, the support part, and a reinforcement part constituting the node for the lower structure of the offshore wind power generator, which is manufactured by a casting method, according to the embodiment of the present invention.

FIG. 9 is a schematic view for describing the node for the lower structure of the offshore wind power generator, which is manufactured by a casting method, according to the embodiment of the present invention.

FIG. 10 is a perspective view for describing the node for the lower structure of the offshore wind power generator, which is manufactured by a casting method, according to the embodiment of the present invention.

### MODES OF THE INVENTION

Hereinafter, detailed embodiments of the present invention will be described in detail with reference to the accompanying drawings. However, the spirit of the present invention is not limited to the presented embodiments, and those skilled in the art who understand the spirit of the present invention may easily propose other regressive inventions or other embodiments included in the scope of the present invention through addition, change, removal, and the like of other components within the same scope of the spirit. However, these embodiments are also included in the scope of the present invention.

A node for a lower structure of an offshore wind power generator according to an embodiment of the present invention relates to a node manufactured by a casting method and coupled to a lower structure of an offshore wind power generator, the node including a body part into which a main pipe is inserted, a support part which is formed to be branched from the body part at a predetermined angle with respect to a height direction and into which a branch pipe is inserted, and a reinforcement part that protrudes from the body part and forms a predetermined radius of curvature to reinforce coupling between the body part and the support part, in which the body part is formed such that a thickness of a portion from which the support part initially branches is greater than a thickness of a portion spaced apart from the support part on the basis of the height direction.

Further, the support part includes an upper support portion formed on a relatively upper side in the height direction and a lower support portion spaced apart from the upper support portion in the height direction and formed on a relatively lower side, in which an angle formed between the upper support portion and the body part is smaller than an angle formed between the lower support portion and the body part, in the height direction.

Further, a diameter of the upper support portion is smaller than a diameter of the lower support portion.

Further, the upper support portion includes a first upper support portion formed with a predetermined angle with respect to a reference surface that is a surface including a central axis of the body part on the basis of the height direction and a second upper support portion formed symmetrical to the first upper support portion with respect to the reference surface.

Further, the reinforcement part includes a first reinforcement portion that reinforces coupling between the first upper support portion and the body part and a second reinforcement part that reinforces coupling between the second upper support portion and the body part, in which at least a portion of the first reinforcement portion overlaps the second reinforcement portion in the height direction.

Further, the node further includes a connection part that forms a predetermined curvature and is coupled to the support part and an adjacent support part, in which the connection part includes a first connection portion that is coupled to an outer circumferential surface of the first upper support portion, an outer circumferential surface of the second upper support portion, and a portion of the body part to receive stress.

Further, the connection part further includes a second connection portion coupled to an outer circumferential surface of the upper support portion, an outer circumferential surface of the lower support portion, and a portion of the body part to receive stress.

Components having the same function within the same scope of the spirit illustrated in the drawings of each embodiment will be described using the same reference numerals.

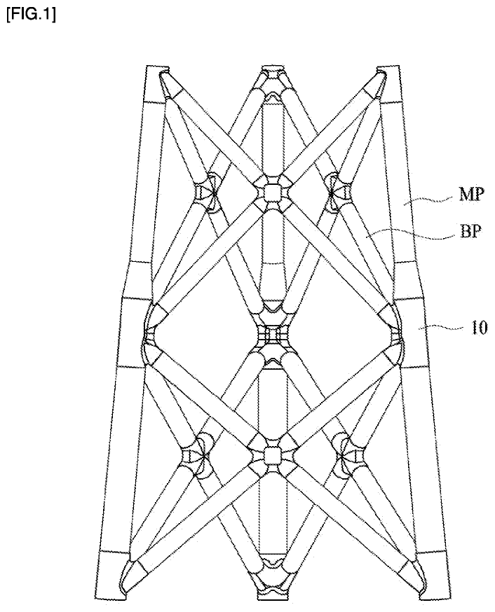

FIG. 1 is a schematic view for describing a node for a lower structure of an offshore wind power generator, which is manufactured by a casting method and is installed on a lower structure, according to an embodiment of the present invention.

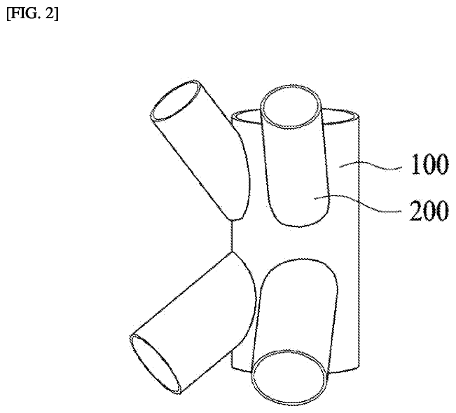

FIG. 2 is a perspective view for describing a node manufactured by a welding method.

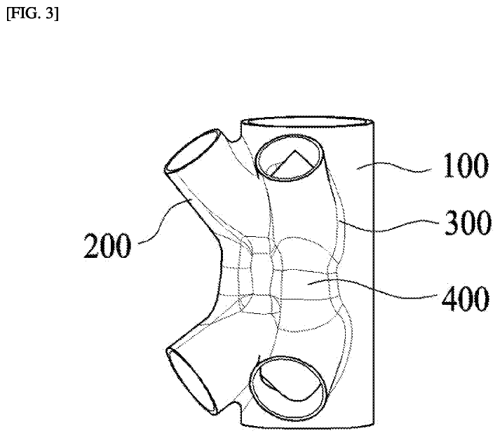

FIG. 3 is a perspective view for describing the node for the lower structure of the offshore wind power generator, which is manufactured by a casting method, according to the embodiment of the present invention.

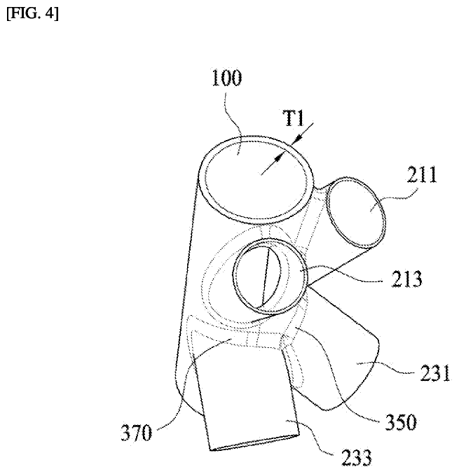

FIG. 4 is a perspective view for describing a body part constituting the node for the lower structure of the offshore wind power generator, which is manufactured by a casting method, according to the embodiment of the present invention.

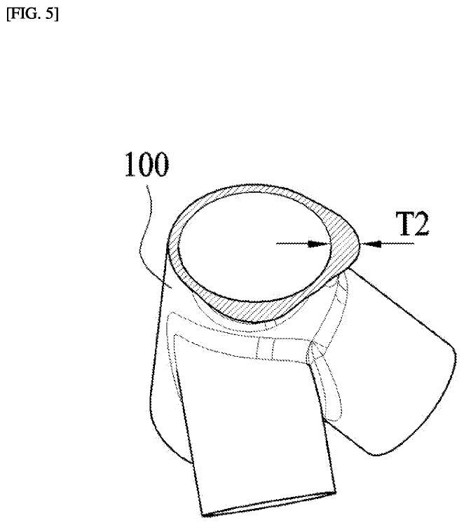

FIG. 5 is a partial sectional-sectional view for describing the body part constituting the node for the lower structure of the offshore wind power generator, which is manufactured by a casting method, according to the embodiment of the present invention.

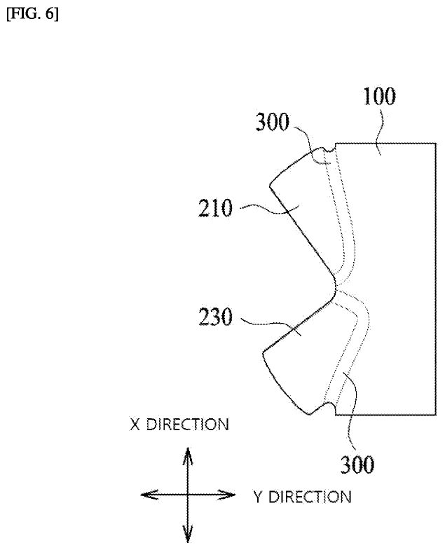

FIG. 6 is a side view for describing the body part and a support part constituting the node for the lower structure of the offshore wind power generator, which is manufactured by a casting method, according to the embodiment of the present invention.

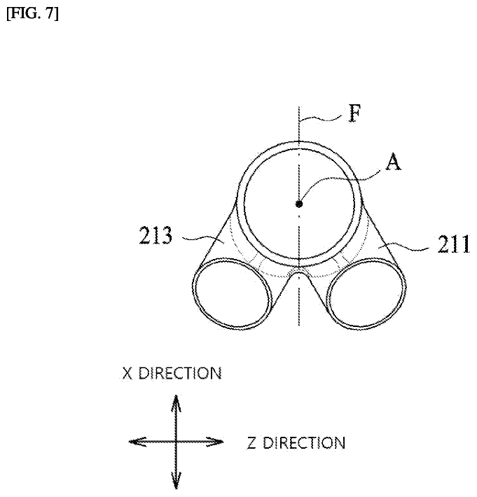

FIG. 7 is a schematic view for describing the body part and the support part constituting the node for the lower structure of the offshore wind power generator, which is manufactured by a casting method, according to the embodiment of the present invention.

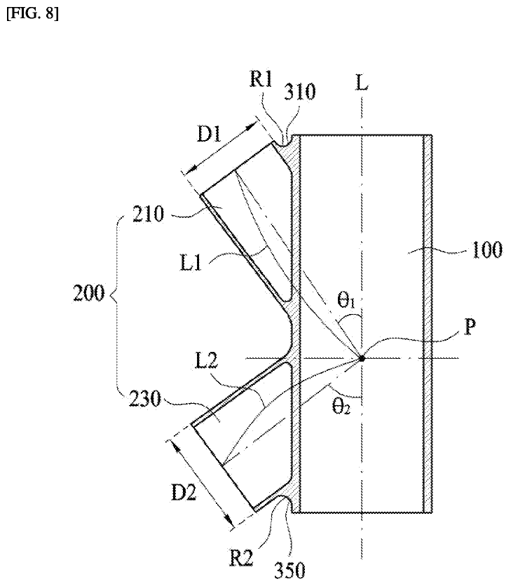

FIG. 8 is a sectional-sectional view for describing the body part, the support part, and a reinforcement part constituting the node for the lower structure of the offshore wind power generator, which is manufactured by a casting method, according to the embodiment of the present invention.

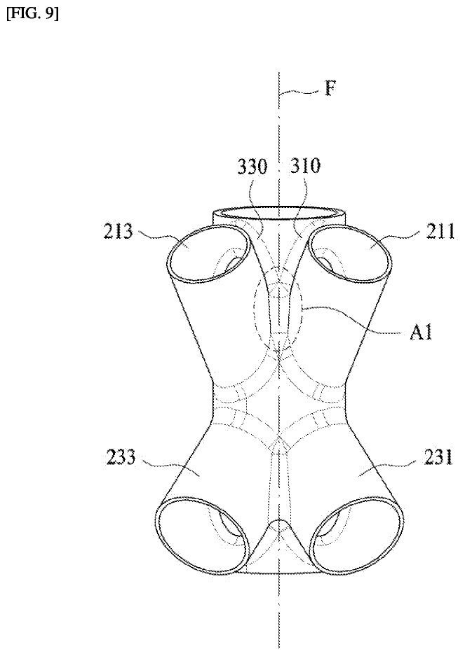

FIG. 9 is a schematic view for describing the node for the lower structure of the offshore wind power generator, which is manufactured by a casting method, according to the embodiment of the present invention.

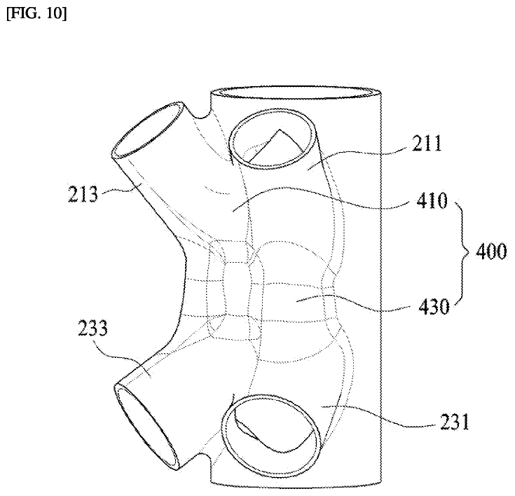

FIG. 10 is a perspective view for describing the node for the lower structure of the offshore wind power generator, which is manufactured by a casting method, according to the embodiment of the present invention.

In the accompanying drawings, in order to more clearly express the technical spirit of the present invention, parts that are not related to the technical spirit of the present invention or that can be easily derived from those skilled in the art are simplified or omitted.

Throughout the specification, when a first part is “connected” to a second part, this includes a case in which the first part is “directly connected” to the second part as well as a case in which the first part is “electrically connected” to the second part with a third part interposed therebetween. Further, when a part “includes” a component, this means that another component is not excluded but may be further included unless otherwise stated, and it should be understood that the presence or addition of one or more other features, numbers, steps, operations, components, parts, or combinations thereof is not excluded in advance.

In the specification, the term “unit” includes a unit implemented by hardware, a unit implemented by software, and a unit implemented using both the hardware and the software. Further, one unit may be implemented using two or more pieces of hardware, and two or more units may be implemented by one piece of hardware.

In the specification, some of operations or functions described as being performed by a terminal or a device may instead be performed by a server connected to the terminal or the device. Likewise, some of operations or functions described as being performed by the server may also be performed by the terminal or the device connected to the server.

Hereinafter, a node for a lower structure of an offshore wind power generator, which is manufactured by a casting method, according to the embodiment of the present invention will be described with reference to FIGS. 1 to 10.

First, in defining terms of directions, as can be seen in FIGS. 6 and 7, an x direction may be a height direction, a y direction may be a width direction of the node, and a z direction may be a longitudinal direction of the node.

The node 10 (hereinafter, referred to as a node) for the lower structure of the offshore wind power generator, which is manufactured by a casting method, according to the embodiment of the present invention may be used in a jacket type lower structure among lower structures that support turbines and large piles installed for offshore wind power generation.

The jacket type lower structure is a structure formed in a grid shape in which steel pipes are arranged to intersect each other over a large space.

In more detail, as can be seen in FIG. 1, the jacket type lower structure includes a leg that is a large-diameter main pipe MP and a brace that is a small-diameter branch pipe BP, and a connection point between the main pipe and the branch pipe forms a truss structure.

The node 10 is a structure used when the main pipe and the branch pipe are connected to each other.

Generally, as can be seen in FIG. 2, the node 10 is manufactured by welding a body part 100 to which the main pipe is coupled and a support part 200 to which the branch pipe is coupled.

The node is manufactured by cutting and then welding methods according to an angle for connecting the main pipe and the branch pipe, but has problems in that it is difficult to cut a thick steel pipe according to an exact required angle, a stress concentration occurs in a welded part, and the lower structure is later deteriorated due to fatigue failure due to repeated loads caused by rotational vibrations of the turbine, wind, and waves.

Thus, in order to prevent these problems, as can be seen in FIG. 3, the node 10 according to the embodiment of the present invention is manufactured by a casting method, so that the node 10 is manufactured to correspond to an angle required for coupling between the body part 100 to which the main pipe is coupled and the support part 200 to which the branch pipe is coupled, and at the same time, when the main pipe and the branch pipe are connected to each other by the node 10, a portion at which a stress is concentrated is reinforced, and thus a stress distribution by the node 10 is implemented.

As can be seen in FIG. 3, the node 10 according to the embodiment of the present invention includes the body part 100 into which the main pipe of the lower structure is inserted, the support part 200 which branches at a predetermined angle with the body part 100 in the height direction and into which the branch pipe of the lower structure is inserted, and a reinforcement part 300 that extends and protrude from the body part 100 and forms a predetermined radius of curvature to reinforce coupling between the body part 100 and the support part 200.

As can be seen FIGS. 6 and 8, the reinforcement part 300 extends and protrudes from the body part 100, forms a predetermined radius of curvature to mediate the coupling between the body part 100 and the support part 200, and at the same time, when the main pipe and the branch pipe are coupled to the node 10, receives the stress concentrated at a connection portion between the body part 100 and the support part 200 and a load due to gravity to distribute the stress and the load, thereby preventing deformation of the body part 100 and the support part 200.

Further, in the body part 100 constituting the node 10, a thickness of a portion from which the support part 200 initially branches may be greater than a thickness of a portion spaced apart from the support part 200, in the height direction.

In more detail, as can be seen in FIGS. 4 and 5, in the body part 100, a thickness T2 of the portion from which the support part 200 initially branches is relatively greater than a thickness T1 of the portion spaced apart from the support part 200, that is, a portion not in contact with the support part 200, in the height direction.

Therefore, since the node 10 is manufactured by a casting method, even when the support part 200 branches from the body part 100 at a predetermined angle, the resulting stress and load are absorbed, and at the same time, even when the main pipe and the branch pipe are coupled to each other, the resulting stress and load are distributed, and thus fatigue failure of the lower structure is prevented later.

Meanwhile, as can be seen in FIG. 6, the support part 200 may include an upper support portion 210 formed on a relatively upper side in the height direction and a lower support portion 230 spaced apart from the upper support portion 210 in the height direction and formed on a relatively lower side.

Here, in the height direction, as can be seen in FIG. 8, an angle θ₁ formed between the upper support portion 210 and the body part 100 is smaller than an angle θ₂ formed between the lower support portion 230 and the body part 100.

In more detail, as illustrated in FIG. 1, the jacket-type lower structure is a triangular pyramid structure in which a width thereof gradually becomes narrower as a portion thereof is positioned on a relatively higher side in the height direction and an angle formed between the main pipe and the branch pipe becomes narrower as the portion thereof is positioned on the relatively higher side.

Accordingly, in the node 10 according to the embodiment of the present invention, the angle θ₁ formed between the upper support portion 210 and the body part 100 is smaller than the angle θ₂ formed between the lower support portion 230 and the body part 100 in the height direction, and thus the main pipe and the branch pipe are easily coupled to each other by the node 10 without separate work such as welding on the jacket type lower structure.

Further, as can be seen in FIG. 8, a diameter D1 of one side of the upper support portion 210 may be smaller than a diameter D2 of one side of the lower support portion 230.

Further, due to characteristics of the jacket type lower structure, diameters of the main pipe and the branch pipe, which are positioned in relatively higher positions, are relatively smaller. Thus, the main pipe and the branch pipe are easily coupled to each other by the node 10, and at the same time, a weight of the node 10 is reduced. Thus, a load directly applied to the lower structure is reduced.

As a result, the lower structure can be more safely maintained by the node 10.

Further, as can be seen in FIG. 8, a length L1 from a center of an outer diameter of one side of the upper support portion 210 to a reference point P that is an intersection point between a virtual center line L of the body part 100 in the height direction and a line L3 from which the upper support portion 210 and the lower support portion 230 branch in the width direction may be relatively greater than a length L2 from the reference point P to a center of an outer diameter of one side of the lower support portion 230.

Accordingly, joining between the upper support portion 210 and the branch pipe is implemented to be relatively greater than joining between the lower support portion 230 and the branch pipe.

This is to compensate for the fact that the diameter D1 of the upper support portion 210 is smaller than the diameter D2 of the lower support portion 230.

That is, a joint length between the upper support portion 210 and the branch pipe is relatively greater than a joint length between the lower support portion 230 and the branch pipe. Thus, a coupling force between the upper support portion 210 and the branch pipe further increases, and at the same time, when the support part 200 is formed, an own weight of the support part 200 is reduced. Thus, a weight applied to the lower structure is reduced.

Furthermore, the reinforcement part 300 may include a first reinforcement portion 310 coupled to the upper support portion 210 and a third reinforcement portion 350 coupled to the lower support portion 230.

Here, as can be seen in FIG. 8, a radius R2 of curvature of the third reinforcement portion 350 may be relatively greater than a radius R1 of curvature of the first reinforcement portion 310.

Since the angle θ₂ formed between the lower support portion 230 and the body part 100 is greater than the angle θ₁ formed between the upper support portion 210 and the body part 100, a relatively high stress may occur.

Thus, the radius R2 of curvature of the third reinforcement portion 350 is relatively greater than the radius R1 of curvature of the first reinforcement portion 310, and thus the lower support portion 230 may more effectively receive the stress due to the angle formed between the lower support portion 230 and the body part 100.

Meanwhile, as can be seen in FIG. 7, the upper support portion 210 may include a first upper support portion 211 forming a predetermined angle with a reference surface F that is a surface including a central axis A of the body part 100 in the height direction and a second upper support portion 213 being symmetrical with the first upper support portion 211 with respect to the reference surface F.

Accordingly, the first upper support portion 211 may form a predetermined angle from the body part 100, the second upper support portion 213 may also form a predetermined angle from the body part 100, and angles formed by the first upper support portion 211 and the second upper support portion 213 may correspond to each other with respect to the reference surface F.

As can be seen in FIG. 9, the lower support portion 230 may also include a first lower support portion 231 formed with a predetermined angle with respect to the reference surface F that is a surface including the central axis A of the body part 100 on the basis of the height direction and a second lower support portion 233 formed symmetrical to the first lower support portion 231 with respect to the reference surface F.

Accordingly, as can be seen in FIG. 9. the first lower support portion 231 may form a predetermined angle from the body part 100, the second lower support portion 233 may also form a predetermined angle from the body part 100, and angles formed by the first lower support portion 231 and the second lower support portion 233 may be correspond to each other with respect to the reference surface F.

Meanwhile, the reinforcement part 300 may further include the first reinforcement portion 310 that reinforces the upper support portion 210, especially, coupling between the first upper support portion 211 and the body part 100 and a second reinforcement portion 330 that reinforces coupling between the second upper support portion 213 and the body part 100.

In more detail, as can be seen in FIG. 9, the reinforcement part 300 may be formed from the body part 100 with respect to each of the first upper support portion 211 and the second upper support portion 213.

Here, at least a portion of the first reinforcement portion 310 overlaps the second reinforcement portion 330 in the height direction.

In more detail, as can be seen in FIG. 6, area A1 is a portion in which the stress is concentrated when the main pipe and the branch pipe are coupled to the node 10.

Thus, the node 10 is formed such that the first reinforcement portion 310 and the second reinforcement portion 330 at least partially overlap each other in the height direction in area A1 in which the stress is concentrated, and thus the stress in area A1 in which the stress is concentrated is more effectively distributed.

In more detail, at least a portion of the first reinforcement portion 310 may overlap the second reinforcement portion 330 in an area including the reference surface F. As a result, the first reinforcement portion 310 and the second reinforcement portion 330 may at least partially overlap each other in the height direction in area A1.

That is, the node 10 is formed such that the first reinforcement portion 310 and the second reinforcement portion at least partially overlap each other in the height direction in area A1, a thicker thickness for area A1 is formed in the width direction, and thus the stress is effectively distributed.

Likewise, as can be seen in FIG. 4, the reinforcement part 300 may include the third reinforcement portion 350 that reinforces coupling between the first lower support portion 231 and the body part 100 and the second reinforcement portion 330 that reinforces coupling between the second lower support portion 233 and the body part 100.

The third reinforcement portion 350 and the second reinforcement portion 330 may also at least partially overlap each other in an area including the reference surface F.

Meanwhile, as can be seen in FIG. 10, the node 10 according to the embodiment of the present invention further includes a connection part 400 that forms a predetermined curvature and is coupled to the support part and an adjacent support part.

The connection part 400 may have a shape being convex toward an inside of the body part 100 in the width direction, may be coupled to portions of the first upper support portion 211, the second upper support portion 213, and the body part 100, and may receive the stress generated by the branch pipe and the main pipe.

To implement this, the connection part 400 includes a first connection portion 410 that is coupled to portions of an outer circumferential surface of the first upper support portion 211, an outer circumferential surface of the second upper support portion 213, and the body part 100 and receives the stress.

In more detail, as can be seen in FIG. 10, the first connection portion 410 may have a shape being convex toward the inside of the body part 100 in the width direction, may be coupled to the outer circumferential surface of the first upper support portion 211, a portion of the body part 100, especially, a portion at which the first upper support portion 211 and the second upper support portion 213 are spaced apart from each other in a longitudinal direction, and the outer circumferential surface of the second upper support portion 213, and thus may distribute the stress and load generated as the branch pipe and the main pipe are coupled to each other by the node 10.

However, it is apparent that the first connection portion 410 may be coupled to the reinforcement part 300 formed in each of the first upper support portion 211 and the second upper support portion 213.

The connection part 400 may also be coupled to portions of the upper support portion 210, the lower support portion 230, and the body part 100 and receive the stress generated by the branch pipe and the main pipe.

To implement this, the connection part 400 further includes a second connection portion 430 that is coupled to portions of an outer circumferential surface of the upper support portion 210, an outer circumferential surface of the lower support portion 230, and the body part 100 and receives the stress.

In more detail, as can be seen in FIG. 10, the second connection portion 430 may have a shape being convex toward the inside of the body part 100 in the width direction, may be coupled to the outer circumferential surface of the upper support portion 210, a portion of the body part 100, especially, a portion at which the upper support portion 210 and the lower support portion 230 are spaced apart from each other in the height direction, and the outer circumferential surface of the lower support portion 230, and thus may distribute the stress and load generated as the branch pipe and the main pipe are coupled to each other by the node 10.

However, the second connection portion 430 may be coupled to the reinforcement part 300 formed in the upper support portion 210 and the lower support portion 230.

As a result, the node 10 is installed on the jacket type lower structure, and thus even when the main pipe and the branch pipe are coupled to each other, occurrence of a stress concentration at a portion in which the main pipe and the branch pipe are coupled to each other can be effectively prevented. Further, a fatigue failure of the lower structure in the future due to repeated loads caused by rotational vibrations of the turbine, wind, and waves can be effectively prevented.

Hereinabove, the configuration and feature of the present invention have been described based on embodiments of the present invention, but the present invention is not limited thereto, and it is apparent to those skilled in the art to which the present invention pertains that various changes or modifications can be made within the spirit and scope of the present invention. Thus, it is noted that the changes or modifications belong to the appended claims.

1. A node for a lower structure of an offshore wind power generator, which is manufactured by a casting method, the node comprising:
a body part into which a main pipe is inserted;
a support part which is formed to be branched from the body part at a predetermined angle with respect to a height direction and into which a branch pipe is inserted; and
a reinforcement part that extends and protrudes from the body part, forms a predetermined radius of curvature, and thus reinforces coupling between the body part and the support part,
wherein the body part is formed such that a thickness of a portion from which the support part initially branches is greater than a thickness of a portion spaced apart from the support part on the basis of the height direction.

2. The node of claim 1, wherein the support part includes:
an upper support portion formed on a relatively high side in the height direction; and
a lower support portion spaced apart from the upper support portion and formed on a relatively lower side, and
an angle formed between the upper support portion and the body part is smaller than an angle formed between the lower support portion and the body part in the height direction.

3. The node of claim 2, wherein a diameter of the upper support portion is smaller than a diameter of the lower support portion.

4. The node of claim 2, wherein the upper support portion includes:
a first upper support portion formed with a predetermined angle with respect to a reference surface that is a surface including a central axis of the body part on the basis of the height direction; and
a second upper support portion formed symmetrical to the first upper support portion with respect to the reference surface.

5. The node of claim 4, wherein the reinforcement part includes:
a first reinforcement portion configured to reinforce coupling between the first upper support portion and the body part; and
a second reinforcement portion configured to reinforce coupling between the second upper support portion and the body part, and
at least a portion of the first reinforcement portion overlaps the second reinforcement portion in the height direction.

6. The node of claim 4, further comprising a connection part formed with a predetermined curvature and coupled to the support part and an adjacent support part,
wherein the connection part includes a first connection portion coupled to portions of an outer circumferential surface of the first upper support portion, an outer circumferential surface of the second upper support portion, and the body part and configured to receive a stress.

7. The node of claim 6, wherein the connection part further includes a second connection portion coupled to portions of an outer circumferential surface of the upper support portion, an outer circumferential surface of the lower support portion, and the body part and configured to receive a stress.
